(19) United States
(12) Patent Application Publication
(10) Pub. No.: US 2010/0066722 A1
(43) Pub. Date: Mar. 18, 2010

(54) INFORMATION REPRODUCTION APPARTUS AND VIDEO DISPLAY APPARATUS

(76) Inventor: Hiroki Mouri, Osaka (JP)

Correspondence Address: MCDERMOTT WILL & EMERY LLP, 600 13TH STREET, NW, WASHINGTON, DC, 20005-3096, US

(21) Appl. No.: 12/531,441

(22) PCT Filed: Nov. 13, 2007
(86) PCT No.: PCT/JP2007/072012

§ 371 Date: Sep. 15, 2009

(30) Foreign Application Priority Data
May 30, 2007 (JP) 2007-143741

(51) Int. Cl. H04L 7/02; G06F 3/038

(52) U.S. Cl. 345/213; 375/359

(57) ABSTRACT

In an asynchronous read channel system, a reference value interpolation-type maximum likelihood decoder ASML having a small circuit scale (e.g., seven taps) is employed. A nonlinear waveform the equalizer SEQ is provided before the maximum likelihood decoder ASML. The nonlinear waveform the equalizer SEQ includes an FIR filter having, for example, four taps, and performs nonlinear waveform equalization with respect to an input digital signal so that only signal components having small amplitudes and high frequencies are amplified. After the nonlinear waveform equalization, the signal is input to the reference value interpolation-type maximum likelihood decoder ASML, which performs maximum likelihood decoding with respect to the signal. Therefore, even when the reference value interpolation-type maximum likelihood decoder includes a smaller number of taps and thus has a small circuit scale, maximum likelihood decoding with a high error correction function can be performed.

### TECHNICAL FIELD

The present invention relates to an information reproduction apparatus which performs maximum likelihood decoding, and a video display apparatus including the information reproduction apparatus.

### BACKGROUND ART

Storage apparatuses and communication apparatuses generally include an information reproduction apparatus. The PRML read channel technique, which extracts data information and timing information from a read information signal, is generally used in the information reproduction apparatus. The PRML read channel technique is conventionally constructed by a technique of combining an analog circuit and a digital circuit on a semiconductor device, and the operating frequency has been increased year by year.

As such an information reproduction apparatus, for example, Patent Document 1 describes a technique of performing frequency and phase control using a VCO (voltage controlled oscillator) when extracting timing information from an analog signal read out from a recording medium, where an analog output signal of a D/A converter (DAC), which is an analog circuit, is used as a signal for the frequency and phase control.

Also, for example, Patent Document 2 describes a technique of replacing a process performed in an analog circuit with a digital circuit in an information reproduction apparatus employing an asynchronous clock, thereby reducing the area and miniaturizing the semiconductor process.

### Patent Document 1: Japanese Unexamined Patent Application Publication No. 2002-8315

Patent Document 2: Japanese Unexamined Patent Application Publication No. H10-69727

### DISCLOSURE OF THE INVENTION

### Problems to be Solved by the Invention

However, since a control system which is an analog circuit is employed in the technique described in Patent Document 1, it is difficult to miniaturize the semiconductor process. Therefore, the area cannot be reduced, and removal of a cause for the variation is a challenge. Moreover, since a frequency and a phase are gradually pulled in using a VCO and a DAC, there is disadvantageously an influence of an initial frequency error. For example, when an information reproduction apparatus is used in a product which requires a broad-band process ranging from 4.321 MHz (CD: 1× speed) to 432 MHz (DVD: 16× speed) to 792 MHz (Blu-ray: 12× speed), the speeds may be suddenly changed, CAV reproduction is performed in which pickup laser may be rapidly moved from the outermost circumference to the innermost circumference, or the like, which cause a steep change in frequency. In such a case, synchronization with a channel clock is not established, so that it disadvantageously takes a time for timing recovery to be stably operated.

On the other hand, the technique described in Patent Document 2 does not have the drawback of Patent Document 1, since a process performed by an analog circuit is replaced with a digital circuit. However, when timing recovery is performed, a plurality of reference values which are used in maximum likelihood decoding are interpolated using a reference value interpolator. Therefore, an interpolation error occurs with respect to the reference values, leading to a decrease in performance, and it is necessary to provide a reference value interpolation-type maximum likelihood decoding unit which employs an adaptive equalization process and has a large number of taps so as to obtain a read channel system employing an asynchronous clock which has performance similar to a read channel system employing a conventional synchronous clock. However, this arrangement would disadvantageously lead to an increase in circuit scale A relationship between the number of taps and the circuit scale (the number of states) of an information reproduction apparatus including such a reference value interpolation-type maximum likelihood decoding unit is shown in FIG. 17. The relationship between the number of taps and the circuit scale (the number of states) will be described. If the number of taps of the reference value interpolation-type maximum likelihood decoding unit is n, the number of states of maximum likelihood decoding is 2ⁿ⁻¹ and the number of branches is 2ⁿ. Note that, since there is a constraint (Run Length Limited, which is hereinafter referred to as RLL) on a minimum distance between transitions of an input data sequence read out from an optical disk, some sequences do not exist, and therefore, the number of states is less than 2ⁿ⁻¹. As an example, FIG. 18 shows a trellis diagram where the number of taps=5 with a constraint of RLL(2, 10), and FIG. 19 shows a trellis diagram where the number of taps=7 with a constraint of RLL(2, 10). As can be seen from FIG. 17, in the maximum likelihood decoding device, the number of states (resolution) increases with an increase in the number of taps, and therefore, for example, the number of registers for storing the results of calculation increases by an amount corresponding to the increase in the number of states and the increase in the number of branches, and the circuit scale increases with an increase in the number of states. Therefore, an information reproduction apparatus employing reference value interpolation-type maximum likelihood decoding has a drawback that the circuit scale needs to be increased so as to achieve maximum likelihood decoding with higher accuracy.

An object of the present invention is to provide an information reproduction apparatus employing reference value interpolation-type maximum likelihood decoding in which maximum likelihood decoding is performed with high accuracy while preventing an increase in circuit scale.

### Solution to the Problems

To achieve the object, attention is paid to the fact that the error correction function is improved if only signal components having small amplitudes and high frequencies are shaped into waveforms having large amplitudes and maximum likelihood decoding is performed with respect to the signal containing the high-frequency components whose waveforms have been shaped into the large amplitudes. The present invention employs a configuration which performs simple nonlinear waveform equalization before reference value interpolation-type maximum likelihood decoding, thereby performing maximum likelihood decoding with high accuracy in an information reproduction apparatus.

Specifically, the present invention provides an information reproduction apparatus for extracting data and recording timings of the data from a received signal, including an asynchronous clock generator configured to generate and output an asynchronous clock which is not necessarily synchronous with the data recording timings of the received signal, a frequency of the asynchronous clock being adjusted so that a rate of oversampling of the received signal with the asynchronous clock is synchronous with the recording timings of the received signal, an A/D converter configured to convert the received signal from an analog signal to a digital signal at timings of the asynchronous clock of the asynchronous clock generator, a nonlinear waveform equalizer having a run length determinator configured to receive digital data sampled by the A/D converter with the timings of the asynchronous clock and determine data having a specific run length contained in the digital data, and configured to perform a nonlinear waveform equalizing process with respect to the digital data from the A/D converter with the timings of the asynchronous clock so that only the data having the specific run length determined by the run length determinator, of the digital data from the A/D converter, is amplified, a timing detector configured to generate a pseudo-synchronous clock based on the output signal of the A/D converter and the asynchronous clock generated by the asynchronous clock generator, and a reference value interpolation-type maximum likelihood decoder configured to perform error correction with respect to an output signal of the nonlinear waveform equalizer at the timings of the asynchronous clock, and thereafter, generate decoded data at timings of the pseudo-synchronous clock of the timing detector.

In the information reproduction apparatus, the nonlinear waveform equalizer performs a nonlinear waveform equalizing process so that only data having a specific run length contained in the output signal of the A/D converter is amplified and data having the other run lengths is passed therethrough without amplification.

In the information reproduction apparatus, the nonlinear waveform equalizer performs a nonlinear waveform equalizing process so that a plurality of pieces of data having respective specific run lengths contained in the output signal of the A/D converter are amplified by different respective amplification factors.

In the information reproduction apparatus, the timing detector generates a frequency control signal which allows a rate of oversampling of the received signal with the asynchronous clock of the asynchronous clock generator to be synchronous with the recording timings of the received signal. The asynchronous clock generator receives the frequency control signal of the timing detector and adjusts a frequency of the asynchronous clock to be generated. The nonlinear waveform equalizer performs a nonlinear waveform equalizing process using a pseudo-synchronous clock generated by the timing detector based on the adjusted asynchronous clock.

In the information reproduction apparatus, the nonlinear waveform equalizer performs a nonlinear waveform equalizing process by performing a pseudo-synchronization process of causing digital data input at the timings of the asynchronous clock to be pseudo-synchronous with data having the timings of the pseudo-synchronous clock of the timing detector, and thereafter, converts the data obtained by the pseudo-synchronization process into data having the asynchronous timings, and outputs the data having the asynchronous timings.

In the information reproduction apparatus, the nonlinear waveform equalizer performs the nonlinear waveform equalizing process at the timings of the pseudo-synchronous clock of the timing detector.

In the information reproduction apparatus, the nonlinear waveform equalizer performs a nonlinear waveform equalizing process using a transversal filter and an LMS (Least Mean Square) algorithm.

The information reproduction apparatus includes a memory configured to previously hold a plurality of sets of coefficient values of the nonlinear waveform equalizer. A set of coefficient values corresponding to an output value of the reference value interpolation-type maximum likelihood decoder is supplied from the memory to the nonlinear waveform equalizer.

The information reproduction apparatus includes a coefficient calculator configured to calculate an optimal coefficient value of the nonlinear waveform equalizer by learning.

In the information reproduction apparatus, a nonlinear waveform equalizing process is performed so that a plurality of pieces of data having respective specific run lengths contained in the output signal of the A/D converter are amplified by different respective amplification factors at the timings of the asynchronous clock of the asynchronous clock generator.

In the information reproduction apparatus, a nonlinear waveform equalizing process is performed so that a plurality of pieces of data having respective specific run lengths contained in the output signal of the A/D converter are amplified by different respective amplification factors at the timings of the pseudo-synchronous clock of the timing detector.

In the information reproduction apparatus, the timing detector generates a frequency control signal which allows a frequency which is an integral multiple of a specific frequency corresponding to an optical disk to be equal to a frequency of an asynchronous clock, based on TOC (Table of Contents) information read out from the optical disk. The asynchronous clock generator receives the frequency control signal of the timing detector, and adjusts a frequency of the asynchronous clock to be generated.

In the information reproduction apparatus, the timing detector generates a frequency control signal which allows a frequency which is an integral multiple of a specific frequency corresponding to an optical disk to be equal to a frequency of an asynchronous clock, based on laser reflectance information of the optical disk. The asynchronous clock generator receives the frequency control signal of the timing detector, and adjusts a frequency of the asynchronous clock to be generated.

The present invention also provides a video display apparatus including an LSI having the aforementioned information reproduction apparatus, and a signal processing circuit configured to obtain audio data and video data based on decoded data obtained by the information reproduction apparatus, and a display terminal configured to receive the audio data and the video data from the LSI, and generate the audio data and display the video data.

In the video display apparatus, the information reproduction apparatus receives the received data from an optical disk including a DVD or a Blu-ray, a wireless communication path, or a wired communication path including an optical fiber, a coaxial cable or a power line path.

Thus, in the present invention, simple nonlinear waveform equalization is performed before reference value interpolation-type maximum likelihood decoding. Therefore, for example, while a reference value interpolation maximum likelihood decoder which has high performance, but has a small circuit scale (seven taps) rather than a circuit scale (thirteen taps), a waveform equalizer which performs a nonlinear equalization process before the reference value interpolation maximum likelihood decoder is configured with an FIR filter having several taps (e.g., four taps), whereby data processing for maximum likelihood decoding is performed with a high error correction process and with high efficiency. As a result, maximum likelihood decoding can be performed with high accuracy while preventing an increase in circuit scale.

### EFFECT OF THE INVENTION

As described above, according to the information reproduction apparatus of the present invention, simple nonlinear waveform equalization is performed before reference value interpolation-type maximum likelihood decoding. Therefore, maximum likelihood decoding with a high error correction function can be performed using a reference value interpolation-type maximum likelihood decoder having a small circuit scale.

### BRIEF DESCRIPTION OF THE DRAWINGS

FIG. 1 shows an overall configuration of an information reproduction apparatus according to a first embodiment of the present invention.

FIG. 2 is a diagram showing an internal configuration of a nonlinear waveform equalizer included in the information reproduction apparatus.

FIG. 3 is a diagram showing an internal configuration of first and second FIR filters included in the nonlinear waveform equalizer.

FIG. 4 is a diagram showing frequency characteristics of the first FIR filter.

FIG. 5 is a diagram showing frequency characteristics of the second FIR filter.

FIG. 6 is a diagram showing an internal configuration of a nonlinear waveform equalizer included in an information reproduction apparatus according to a second embodiment of the present invention.

FIG. 7(a) is a diagram showing a configuration of a run length determinator included in the nonlinear waveform equalizer. FIG. 7(b) is a diagram showing a signal waveform of 3T-3T.

FIG. 8 is a diagram schematically showing a configuration of an information reproduction apparatus according to a third embodiment of the present invention.

FIG. 9 is a diagram schematically showing a configuration of an information reproduction apparatus according to a fourth embodiment of the present invention.

FIG. 10 is a diagram showing an overall configuration of an information reproduction apparatus according to a fifth embodiment of the present invention.

FIG. 11 is a diagram showing an overall configuration of an information reproduction apparatus according to a sixth embodiment of the present invention.

FIG. 12 is a diagram showing an overall configuration of an information reproduction apparatus according to a seventh embodiment of the present invention.

FIG. 13 is a diagram showing an internal configuration of an oscillation frequency controller included in an information reproduction apparatus according to an eighth embodiment of the present invention.

FIG. 14 is a diagram showing an internal configuration of an oscillation frequency controller included in an information reproduction apparatus according to a ninth embodiment of the present invention.

FIG. 15(a) is a diagram showing a video display apparatus according to a tenth embodiment of the present invention. FIG. 15(b) is a diagram showing another video display device.

FIG. 16 is a diagram showing focus deviation-vs-bit error rate characteristics showing an effect of the present invention.

FIG. 17 is a diagram showing a relationship between the number of taps and the number of states of a reference value interpolation-type maximum likelihood decoder.

FIG. 18 is a trellis diagram of the reference value interpolation-type maximum likelihood decoder where the number of taps=5.

FIG. 19 is a trellis diagram of the reference value interpolation-type maximum likelihood decoder where the number of taps=7.

### DESCRIPTION OF THE REFERENCE CHARACTERS

ALPF analog low-pass filter
ADC A/D converter
DEQ digital equalizer
BC baseline controller
SEQ equalizer (nonlinear waveform equalizer)
ASML reference value interpolation-type maximum likelihood decoder
TDL timing detector
VCO voltage controlled oscillator (asynchronous clock generator)
FDAC D/A converter
FIR1 first FIR filter
FIR2 second FIR filter
TD threshold determinator
DA delay adjuster
RLD run length determinator
CNT counter
ACUM accumulator
DIV divider
CMP comparator
MEM memory
60 LSI
61 display terminal

### BEST MODE FOR CARRYING OUT THE INVENTION

Hereinafter, embodiments of the present invention will be described with reference to the accompanying drawings.

### Embodiment 1

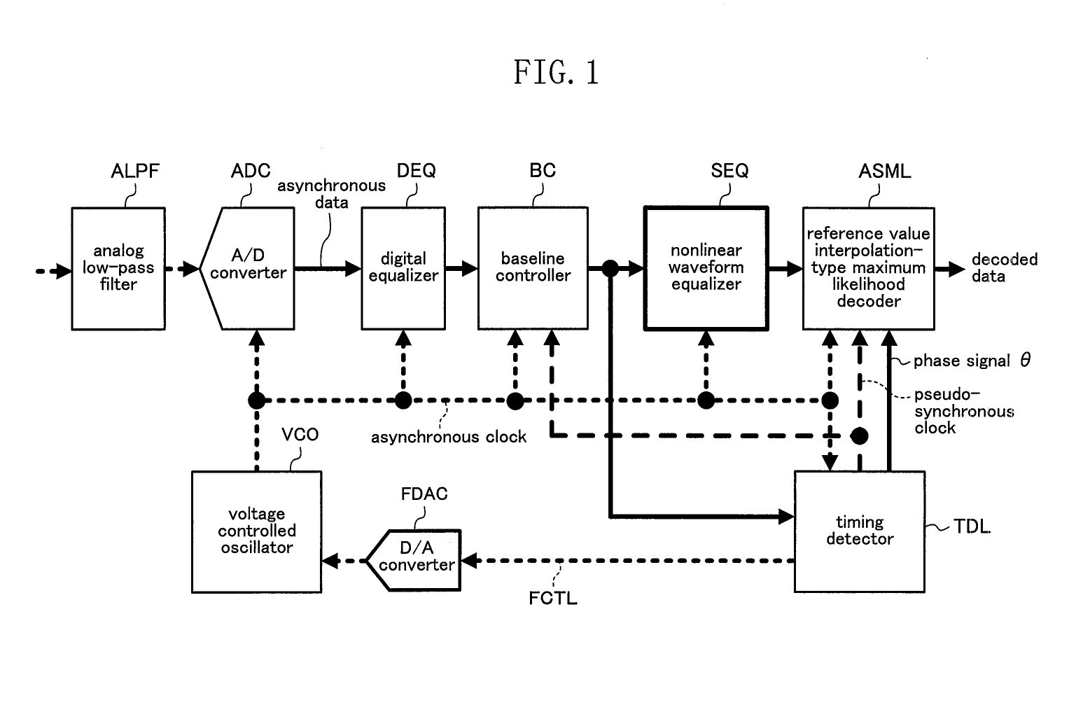

FIG. 1 shows an overall configuration of an information reproduction apparatus according to a first embodiment of the present invention.

In FIG. 1, an analog signal read out from an optical disk, such as a DVD, a Blu-ray or the like, is received by an analog low-pass filter ALPF, which removes high-frequency noise components. The analog received signal obtained by the removal is converted from analog data into digital data by an A/D converter ADC. The digital data is represented by bits having 2ⁿ levels of gray. For example, when n=7, the digital data has 128 levels of gray.

A signal having a specific band in the digital data obtained by the A/D conversion is amplified by a digital equalizer DEQ. A baseline controller BC detects a DC offset component and a low-frequency fluctuation component contained in a reproduced RF signal from reproduced data after waveform equalization by the digital equalizer DEQ, and subtracts these components from the original signal, thereby performing DC offset correction. An equalizer (nonlinear waveform equalizer) SEQ performs a nonlinear waveform equalizing process with respect to the DC offset-corrected data. The nonlinear waveform equalizing process will be described in detail below.

Also, in FIG. 1, a voltage controlled oscillator (asynchronous clock generator) VCO generates an asynchronous clock having a predetermined frequency. The timings of the asynchronous clock is not necessarily synchronous with the recording timings of data recorded in a recording medium, such as a DVD, a Blu-ray or the like, from which information is to be reproduced.

Moreover, in FIG. 1, a timing detector TDL detects a sync pattern which is a data format specific to, for example, a DVD using an output of the baseline controller BC, performs counting to measure an interval between a sync pattern and the next sync pattern, calculates a ratio between the cycle of the data recording timings contained in a received signal from an optical disk, such as a DVD, and the cycle of the asynchronous clock generated by the voltage controlled oscillator VCO, based on the count value, and thins the asynchronous clock based on the cycle ratio, thereby generating a pseudo-synchronous clock pseudo-synchronous with the data recording timings. Also, the timing detector TDL generates a phase signal θ having an asynchronous sample clock where the data recording timings contained in the received signal are a reference. The phase signal θ is output to a reference value interpolation-type maximum likelihood decoder ASML described below. Moreover, the timing detector TDL outputs a frequency control signal FCTL for controlling the voltage controlled oscillator VCO. The frequency control signal FCTL is converted into an analog value by a D/A converter FDAC. Based on the resultant analog value, the voltage controlled oscillator VCO changes the oscillation frequency of the asynchronous clock. The changed asynchronous clock is supplied to the A/D converter ADC, the digital equalizer DEQ, the baseline controller BC, the equalizer (nonlinear waveform equalizer) SEQ, and the reference value interpolation-type maximum likelihood decoder ASML described below.

Data which has been nonlinearly waveform-equalized by the equalizer (nonlinear waveform equalizer) SEQ is input to the reference value interpolation-type maximum likelihood decoder ASML.

Briefly, the reference value interpolation-type maximum likelihood decoder ASML performs decoding to obtain most likely data by searching for a reference value sequence which is closest to a digital data sequence input from the baseline controller BC via the equalizer (nonlinear waveform equalizer) SEQ. This input digital data and the previously stored reference values are each asynchronous with the data recording timings contained in the received signal. However, the decoded data is caused to be pseudo-synchronous by using the pseudo-synchronous clock output by the timing detector TDL. In other words, the reference value interpolation-type maximum likelihood decoder ASML not only performs maximum likelihood decoding, but also simultaneously performs conversion of asynchronous sample data into synchronous data.

The reference value interpolation-type maximum likelihood decoder ASML is configured to have several taps (e.g., seven taps), though not shown, and include three functional blocks of reference value interpolation, reference value learning, and maximum likelihood decoding. The reference value interpolation block generates reference values by interpolation as follows. Specifically, assuming that one cycle of channel bits is 2π and a boundary between channel bits is phase 0π (i.e., zero phase), a plurality of reference values based on zero phase are previously stored. An input to the reference value interpolation-type maximum likelihood decoder ASML is not completely synchronously sampled data, i.e., is asynchronous sample data. Therefore, when a branch metric for maximum likelihood decoding is obtained, the zero-phase-based reference values cannot be directly used. It is necessary to generate reference values, depending on a phase of the asynchronous sample clock at which sampling is performed, i.e., the phase signal 0 of the asynchronous sample clock from the timing detector TDL. The reference values are generated by performing, for example, linear interpolation with respect to two zero-phase-based reference values corresponding to two successive data sequences using the phase signal θ as a parameter. Although it is assumed in this embodiment that the zero-phase-based reference values are used as reference values, reference values based on the phase π (π-phase-based reference values) can be used, or alternatively, reference values based on other phases can be used.

Also, in the reference value interpolation-type maximum likelihood decoder ASML, the reference value learning block adaptively modifies each zero-phase-based reference value by learning. The learning of the zero-phase-based reference values is used for the modification of the zero-phase-based reference values in accordance with a predetermined learning rule based on an error (x−r) between an input signal x to the reference value interpolation-type maximum likelihood decoder ASML and a reference value r generated as a result of interpolation performed by the reference value interpolation block, and the phase signal θ of the asynchronous sample clock from the timing detector TDL. Moreover, the maximum likelihood decoding block of the reference value interpolation-type maximum likelihood decoder ASML searches for a reference value sequence at phase θ which is closest to a digital data sequence sampled with an asynchronous sample clock having phase θ input from the baseline controller BC via the equalizer (nonlinear waveform equalizer) SEQ, thereby performing decoding to obtain most likely data.

Next, a configuration of the equalizer (nonlinear waveform equalizer) SEQ will be described.

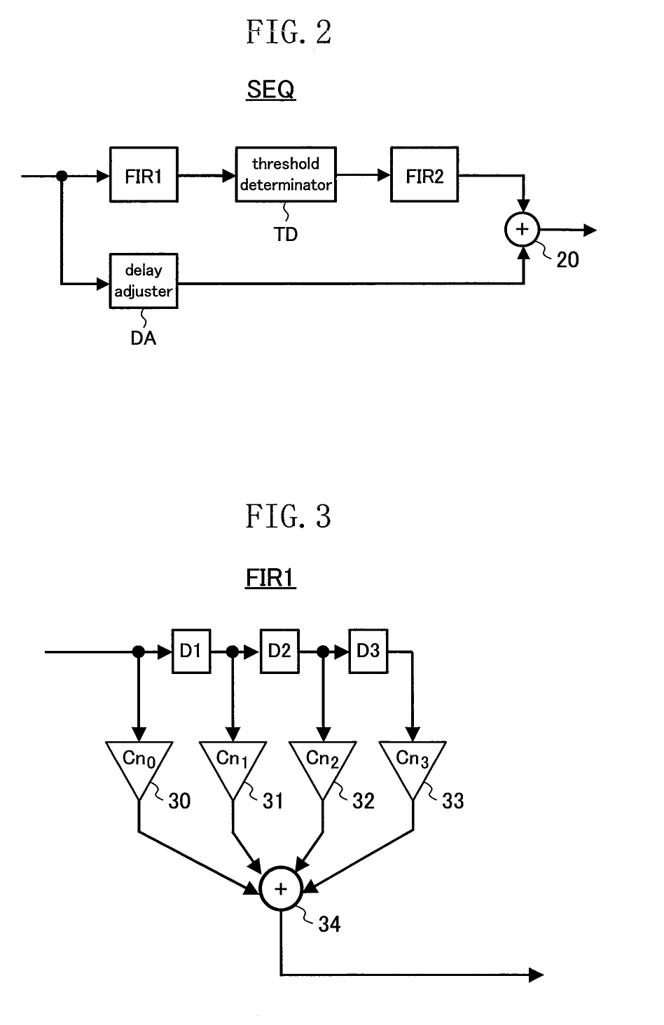

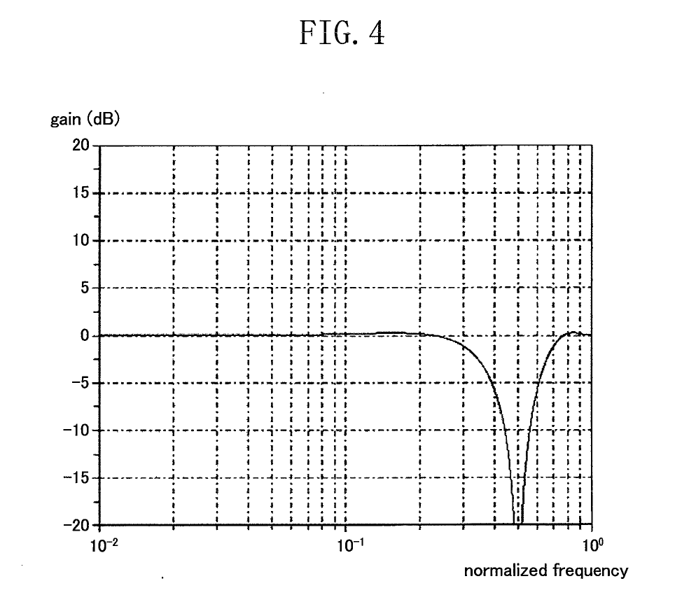

FIG. 2 shows an internal configuration of the equalizer (nonlinear waveform equalizer) SEQ. In the equalizer (nonlinear waveform equalizer) SEQ of FIG. 2, an FIR filter FIR1 performs a linear interpolation process with respect to data and is operated with an asynchronous clock. The FIR filter FIR1 is a digital filter having frequency characteristics as shown in FIG. 4. The frequency characteristics are substantially flat with respect to an input signal.

In FIG. 2, data which has been linearly interpolated by the FIR filter FIR1 is categorized by a threshold determinator TD. When the value of the data is smaller than or equal to a specific threshold, the threshold determinator TD transfers the data to the following FIR filter FIR2 which emphasizes (amplifies) a signal in a specific band. Conversely, when the value of the data is larger than or equal to the specific threshold, the threshold determinator TD outputs the threshold itself.

The threshold determinator TD initially monitors several pieces of sample data, and compares or determines the sign of current data with the sign of data immediately before the current data. As a result of the comparison or determination, the threshold determinator TD outputs the same threshold when these signs are the same, and updates the threshold using Expression 1 described below and learns the updated threshold when these signs are different, which is repeatedly performed.

$$th ( k + 1 ) = th ( k ) + \frac{c \times abs \{ IP ( 5 ) - IP ( 0 ) \} - th ( k )}{n} \qquad ( Expression 1 )$$

An example of the specific threshold in the threshold determinator TD will be described. For example, when the optical disk is a Blu-ray, then if digital data 1, 0 are recorded with the NRZI (Non Return to Zero Inverse) scheme, there is a constraint RLL (Run Length Limited) (n, m)=RLL(1, 7) which limits the number of consecutive 0s between 1 and 1 to a range of no less than n and less than m. Therefore, in this case, the shortest combination of run lengths (e.g., . . . 11001100 . . . ) is 2T-2T (T is a channel time). Therefore, a signal component having this specific run length 2T is amplified and emphasized by the following FIR filter FIR2, while the other signals are passed through the following FIR filter FIR2 without amplification or emphasizing and are limited to the threshold. Also, in the case of a DVD, the shortest combination of run lengths is a signal component having a specific run length of 3T. Therefore, in this case, the signal component having a specific run length of 3T is amplified and emphasized by the following FIR filter FIR2, while the other signals are passed through the following FIR filter FIR2 without amplification or emphasizing and are limited to the threshold. A delay adjuster DA adjusts a delay of data. An adder 20 adds an output of the FIR filter FIR2 and an output of the delay adjuster DA, and a result of the addition is an output signal of the equalizer SEQ.

An internal configuration of the FIR filter FIR1 is shown in FIG. 3. The FIR filter FIR1 of FIG. 3 includes three delay devices D1 to D3 connected in series, four multipliers 30 to 33, and a single adder 34. The first multiplier 30 multiplies an input signal to the first delay device D1 by a coefficient value (tap coefficient) Cn0. The second multiplier 31 multiplies an output signal of the first delay device D1 by a coefficient value Cn1. The third multiplier 32 multiplies an output signal of the second delay device D2 by a coefficient value Cn2. The fourth multiplier 33 multiplies an output signal of the final delay device D3 by a coefficient value Cn3. The adder 34 adds all the outputs of the four multipliers 30 to 33. A result of the addition of all the outputs is an output signal of the FIR filter FIR1. Here, by changing the coefficient values Cn0 to Cn3 as appropriate, an amplification gain can be changed for each band. The FIR filter FIR1 changes the coefficient values Cn0 to Cn3 so that the gain is zero in a low frequency band of 0.2 or less where the channel frequency is normalized to 10⁰ as shown in the frequency characteristics of FIG. 4.

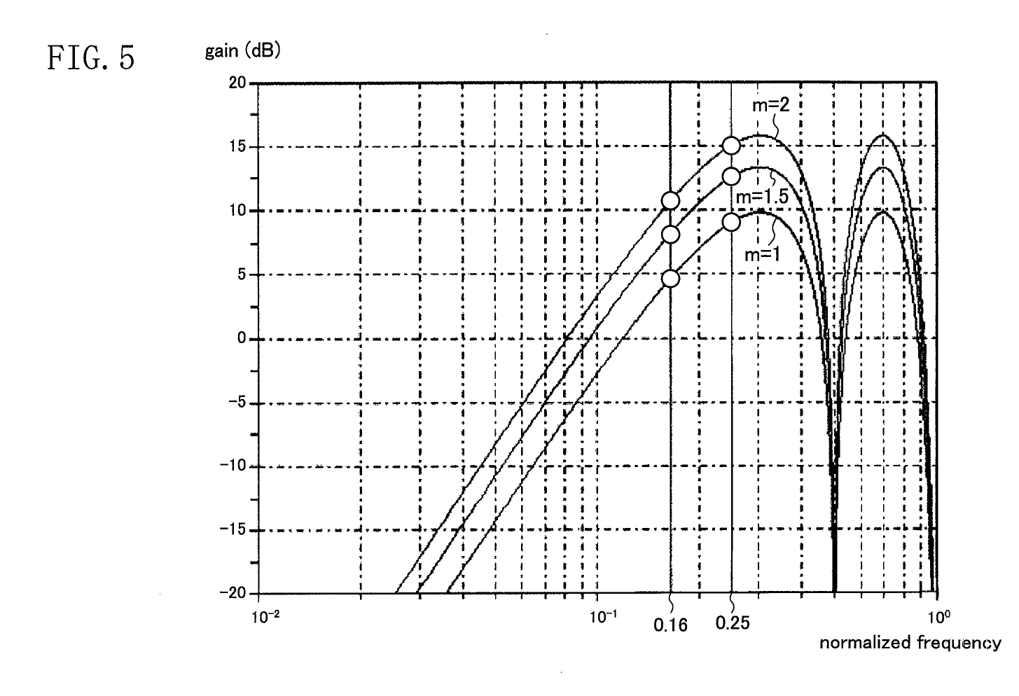

On the other hand, in the equalizer (nonlinear waveform equalizer) SEQ of FIG. 2, the FIR filter FIR2 has an internal configuration similar to that of the FIR filter FIR1 shown in FIG. 3. In the FIR filter FIR2, when the coefficients Cn0 to Cn3 of the four multipliers are tap coefficients −m, m, m and −m, filter frequency characteristics where the value of m takes three different values m=1, m=1.5 and m=2 are shown in FIG. 5.

In FIG. 5, for example, Blu-rays have the following frequency characteristics. A signal having a run length of 2T composed of a 4T component of 2T-2T (1100 or 0011) is the shortest pattern sequence, and this pattern sequence is a signal having the highest frequency component. Consequently, the equalizer has a frequency characteristic to amplify the pattern sequence of the 4T component, i.e., a pattern sequence having a frequency which is (¼)*Tch (Tch is the channel frequency)=0.25 with respect to the normalized frequency by the highest amplification factor. Also, DVDs have the following frequency characteristics. A signal having a run length of 3T composed of a 6T component of 3T-3T (111000 or 000111) is the shortest pattern sequence, and this pattern sequence is a signal having the highest frequency component. Consequently, the equalizer has a frequency characteristic to amplify the pattern sequence of the 6T component, i.e., a pattern sequence having a frequency which is (⅙)*Tch=0.16 with respect to the normalized frequency by the highest amplification factor. In FIG. 5, a gain of as high as five or more can be obtained for both 0.25 and 0.16 with respect to the normalized frequency.

### Embodiment 2

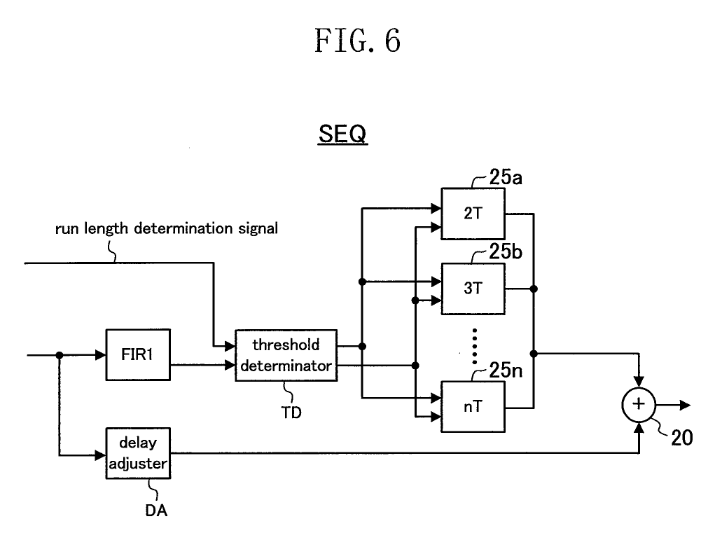

FIG. 6 shows a second embodiment according to the present invention.

FIG. 6 shows another internal configuration of the equalizer (nonlinear waveform equalizer) SEQ of FIG. 1.

The equalizer (nonlinear waveform equalizer) SEQ of FIG. 6 has a digital filter (FIR filter FIKI) which performs a linear interpolation process, a threshold processor TD which receives a run length determination signal, determines a run length contained in the received signal, and performs a threshold process, depending on the determined run length, and n amplification blocks 25a to 25n which amplify only the run length based on the processed threshold.

Therefore, in this embodiment, for example, when the recording medium is a Blu-ray, there is a specific data sequence having a run length of 2T to 8T, and when the recording medium is a DVD, there is a specific data sequence having a run length of 3T to 11T. Therefore, the amplitudes of waveforms having a run length of 2T, 3T and the like which have an amplitude considerably smaller than that of 10T, 11T and the like and for which error is more likely to occur, are separately amplified (emphasized) by the separate corresponding amplification blocks 25a and 25b, and therefore, are more clearly distinguished from the other run lengths.

Note that the operation of ON/OFF of each of the amplification blocks 25a to 25n is selected in accordance with a control signal (not shown). Therefore, each of the amplification blocks 25a to 25n is operated only when receiving data of the corresponding run length, whereby power consumption can be further reduced than when the calculation process is invariably performed.

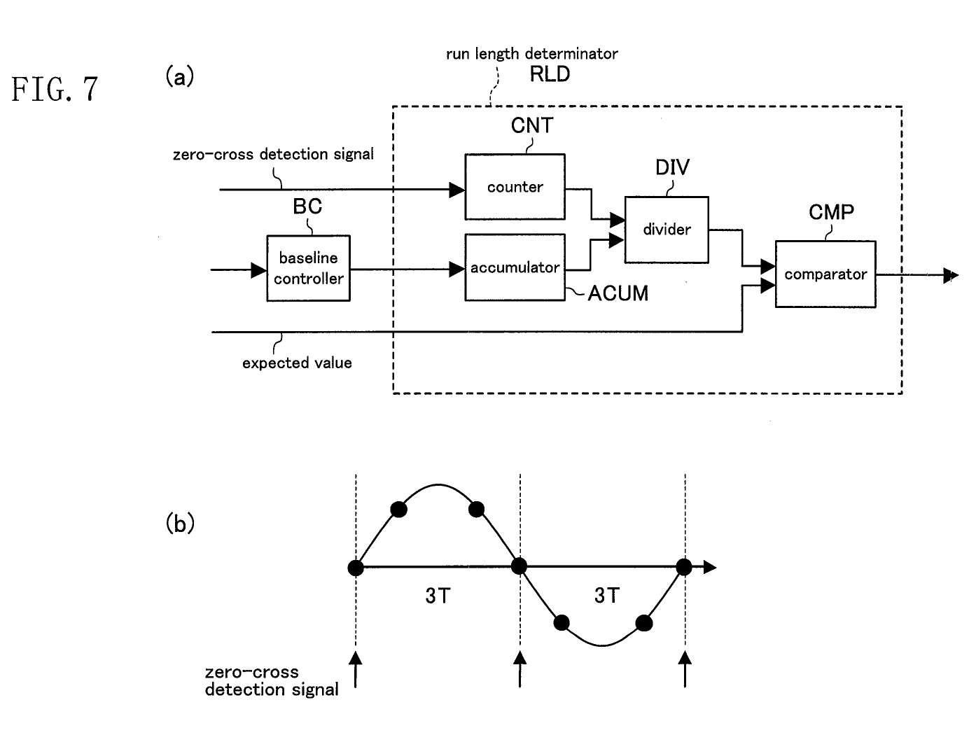

FIG. 7(a) shows a configuration of a run length determinator RLD which outputs the run length determination signal.

The run length determinator RLD of FIG. 7(a) has a counter CNT which counts a zero-cross detection signal, an accumulator ACUM which accumulates output values of the baseline controller BC, a divider DIV, and a comparator CMP which compares a result of the division with an expected value.

The expected value means an amplitude value when channel synchronization is established in an ideal state. Specifically, for example, in the case of a signal having a run length of 3T, a largest amplitude value thereof is the expected value. Since there is an amplitude corresponding to each run length, the largest amplitude value is previously stored in a memory or the like.

Even when data is oversampled by a factor of n at zero-cross detection signal intervals, then if the number of samples is divided by the number of counts in the sampling section of the zero-cross detection signal, the resultant value is substantially the same expected value as that of a system which is synchronous with channel data. For example, in the case of a channel synchronization sample waveform (3T-3T) shown in FIG. 7(b), it can be seen that the count value in the zero-cross interval is 2, the accumulated value is 3+3=6, and the division is 6/2=3, so that the run length is 3 as compared to the expected value. By contrast, in the case of the oversampling rate=2.0x, it can be seen that 2.5+3+3.5+3+2.5=14.5 and 14.5/5=2.9, so that the run length is also 3T. Therefore, the run length determinator RLD having the configuration of FIG. 7(a) has a circuit configuration in which the run length is obtained using the count value and the accumulated value.

### Embodiment 3

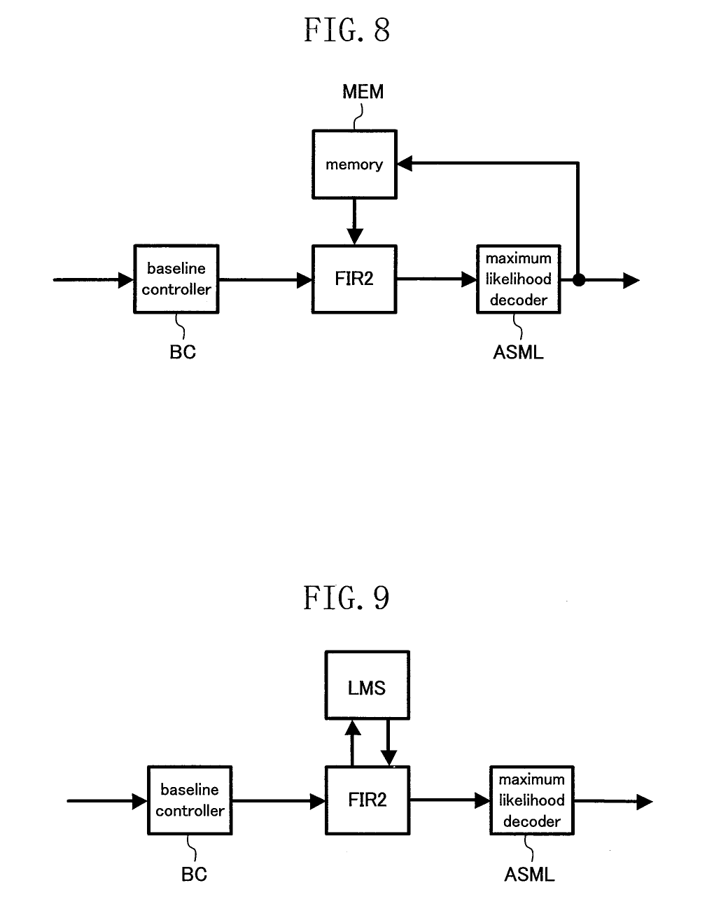

FIG. 8 shows a configuration of an equalizer (nonlinear waveform equalizer) SEQ in an information reproduction apparatus according to a third embodiment of the present invention.

In the configuration of FIG. 8, each coefficient value of an FIR filter FIR2 of the equalizer (nonlinear waveform equalizer) SEQ before the reference value interpolation-type maximum likelihood decoder ASML is changed with reference to a result of the reference value interpolation-type maximum likelihood decoder ASML.

Specifically, a memory MEM previously stores a plurality of sets of coefficients Cn0 to Cn3 of the FIR filter FIR2 shown in FIG. 3. These coefficient sets are previously associated with output values of the reference value interpolation-type maximum likelihood decoder ASML. An appropriate coefficient set corresponding to an actual output value of the reference value interpolation-type maximum likelihood decoder ASML is read out from the memory MEM, and is reflected on a coefficient set of the FIR filter FIR2.

### Embodiment 4

FIG. 9 shows a configuration of an equalizer (nonlinear waveform equalizer) SEQ in an information reproduction apparatus according to a fourth embodiment of the present invention.

In FIG. 9, the equalizer SEQ includes an FIR filter FIR2 which is operated with an asynchronous clock, and an LMS device LMS which employs an LMS (Least Mean Square) algorithm. The LMS device LMS has a coefficient calculator (not shown) which performs adaptive learning with respect to the coefficients Cn0 to Cn3 of the FIR filter FIR2 of FIG. 3 for BC output data input to the FIR filter FIR2, whereby an optimal tap coefficient is reflected on the FIR filter FIR2.

### Embodiment 5

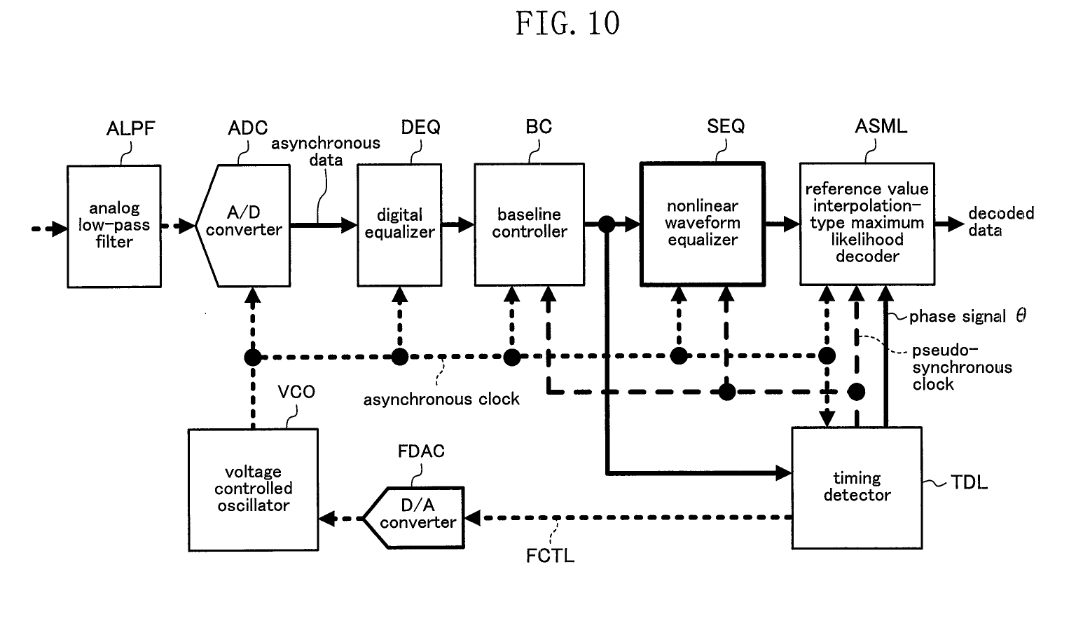

FIG. 10 shows a configuration of an information reproduction apparatus according to a fifth embodiment of the present invention.

In this embodiment, an equalizer (nonlinear waveform equalizer) SEQ receives data which has been sampled with an asynchronous clock and converts the data into data which is sampled with a pseudo-synchronous clock (pseudo-synchronization process) before performing a nonlinear waveform equalizing process with the pseudo-synchronous clock.

Note that, conversely, in this equalizer (nonlinear waveform equalizer) SEQ, when data is output, data which has been sampled with the pseudo-synchronous clock is converted into data which is sampled with the asynchronous clock before being output.

### Embodiment 6

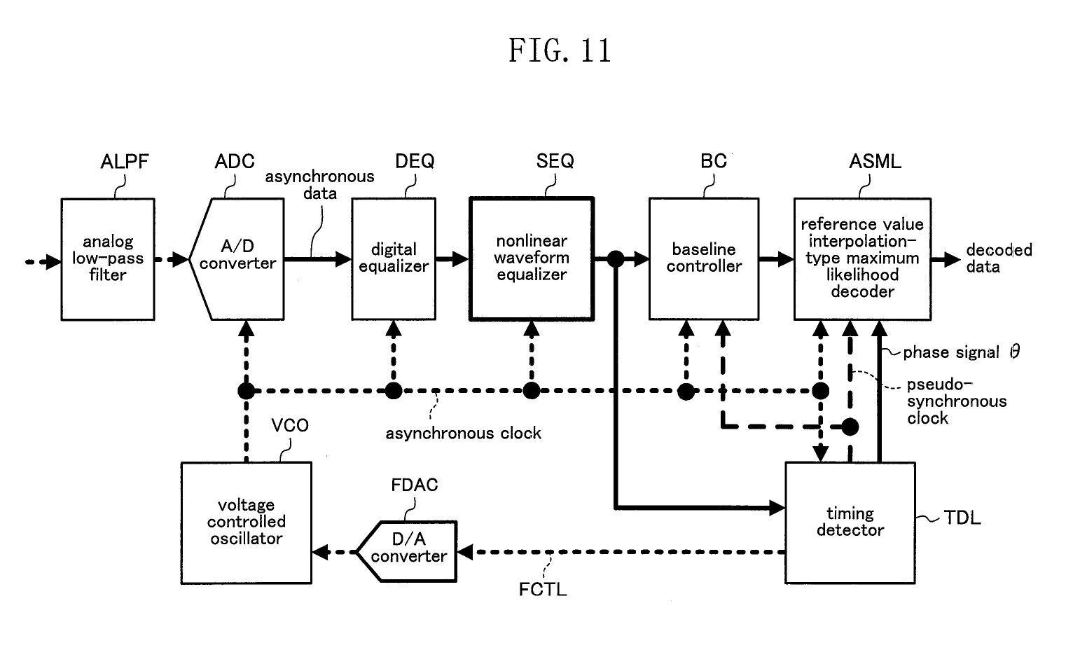

FIG. 11 shows a configuration of an information reproduction apparatus according to a sixth embodiment of the present invention.

In this embodiment, an equalizer (nonlinear waveform equalizer) SEQ which is operated with an asynchronous clock is provided between a digital equalizer DEQ and a baseline controller BC. The other portions of the configuration are similar to those of FIG. 1.

### Embodiment 7

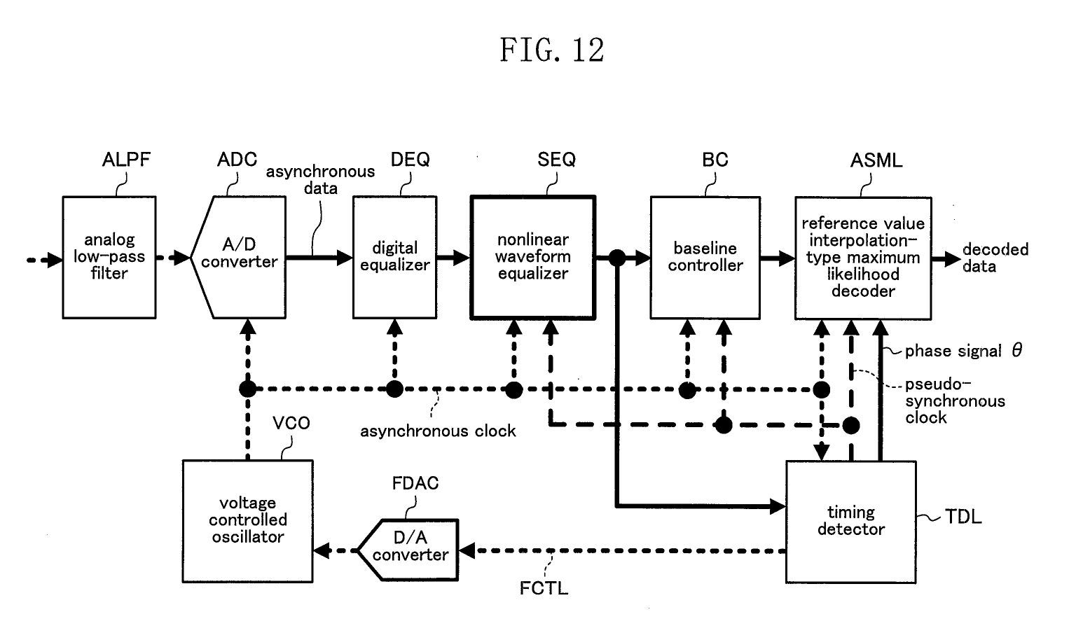

FIG. 12 shows a configuration of an information reproduction apparatus according to a seventh embodiment of the present invention.

This embodiment shows a variation of the information reproduction apparatus of FIG. 11. In FIG. 11, an equalizer (nonlinear waveform equalizer) SEQ is operated with an asynchronous clock, and in addition, a pseudo-synchronous clock of a timing detector TDL is also input thereto as in FIG. 10. Data which has been sampled with the asynchronous clock is converted into data which is sampled with the pseudo-synchronous clock before a nonlinear waveform equalizing process is performed with the pseudo-synchronous clock. Thereafter, the data which has been sampled with the pseudo-synchronous clock is converted into data which is conversely sampled with the asynchronous clock before being output.

### Embodiment 8

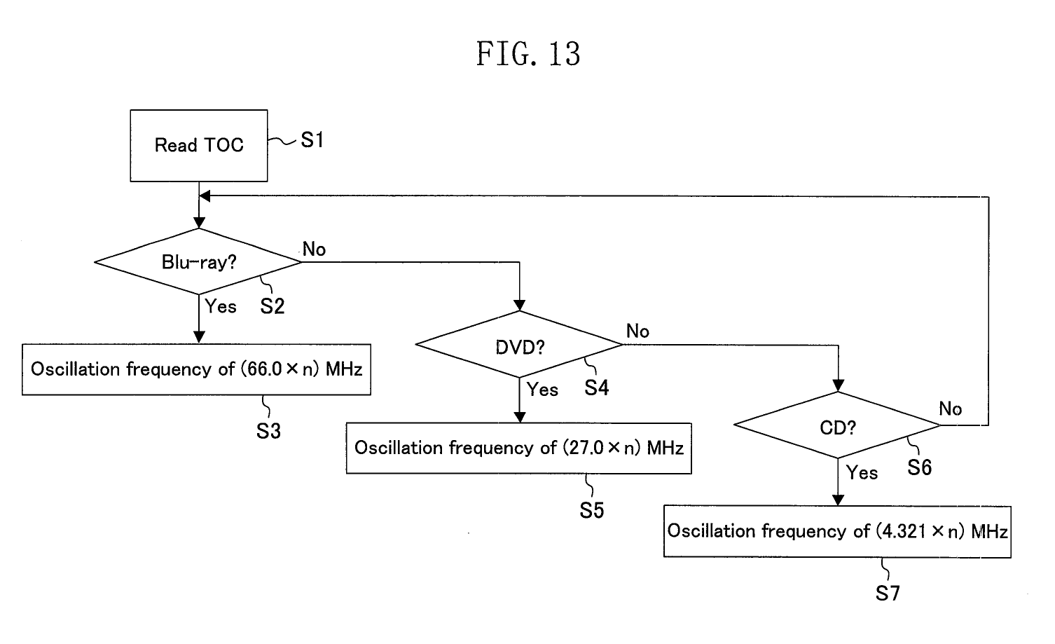

FIG. 13 shows a configuration of an information reproduction apparatus according to an eighth embodiment of the present invention.

This embodiment relates to frequency control of an asynchronous clock generated by a voltage controlled oscillator VCO. In this embodiment, a TOC (Table of Contents) which is read out from a recording medium, such as an optical disk or the like, is used to cause the frequency of the asynchronous clock generated by the voltage controlled oscillator VCO to be equal to an oscillation frequency which is the 1× speed of a media from which information is to be reproduced.

Specifically, in FIG. 13, a TOC is read from an optical disk in step S1, and thereafter, it is determined in steps S2, S4 and S6 whether or not a recording medium from which information is to be reproduced is a Blu-ray, a DVD and a CD, respectively. When the recording medium is a Blu-ray, the asynchronous clock generated by the voltage controlled oscillator VCO is controlled in step S3 so that the asynchronous clock has a specific oscillation frequency of (66.0×n) MHz (n is an integer of one or more). When the recording medium is a DVD, the asynchronous clock generated by the voltage controlled oscillator VCO is controlled in step S5 so that the asynchronous clock has a specific oscillation frequency of (27.0×n) MHz. When the recording medium is a CD, the asynchronous clock generated by the voltage controlled oscillator VCO is controlled in step S7 so that the asynchronous clock has a specific oscillation frequency of (4.321×n) MHz.

### Embodiment 9

Next, a ninth embodiment of the present invention will be described.

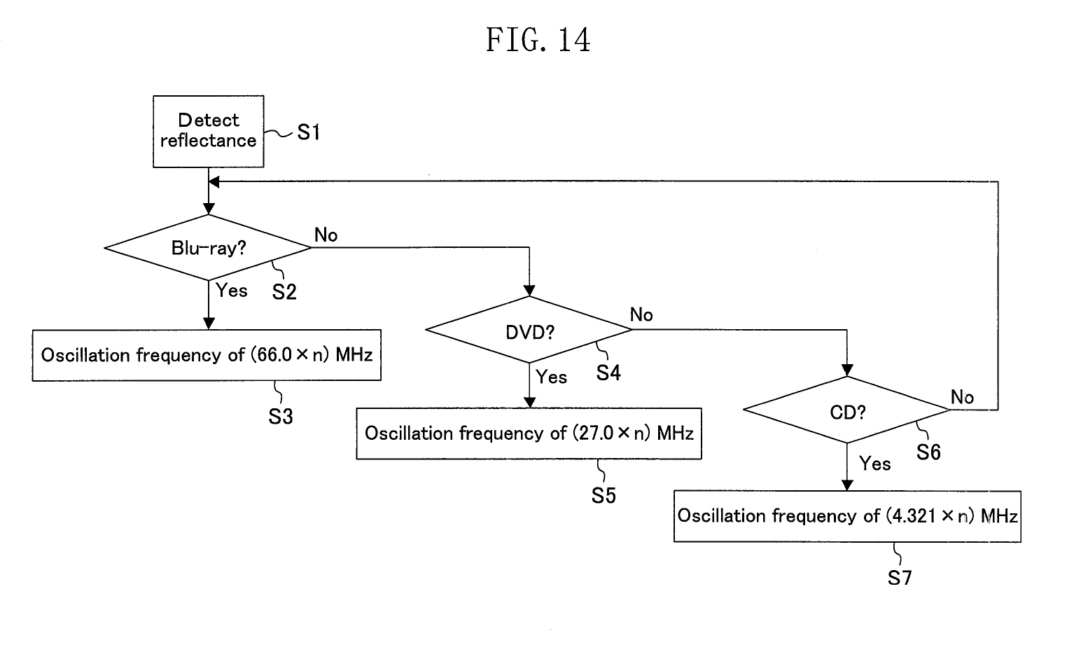

FIG. 14 shows a variation of the frequency control of an asynchronous clock of FIG. 13. In FIG. 13, the control is performed based on a TOC (Table of Contents) from an optical disk. In this embodiment, the reflectance of laser light with respect to a recording medium, such as an optical disk or the like, is sensed, and the frequency of an asynchronous clock generated by a voltage controlled oscillator VCO is controlled based on the reflectance so that the frequency is equal to an oscillation frequency of the 1× speed of a medium from which information is to be reproduced.

This embodiment is different from FIG. 13 only in that, in step S1 of FIG. 14, the reflectance of laser light with respect to a recording medium is sensed, and therefore, the other points will not be described.

### Embodiment 10

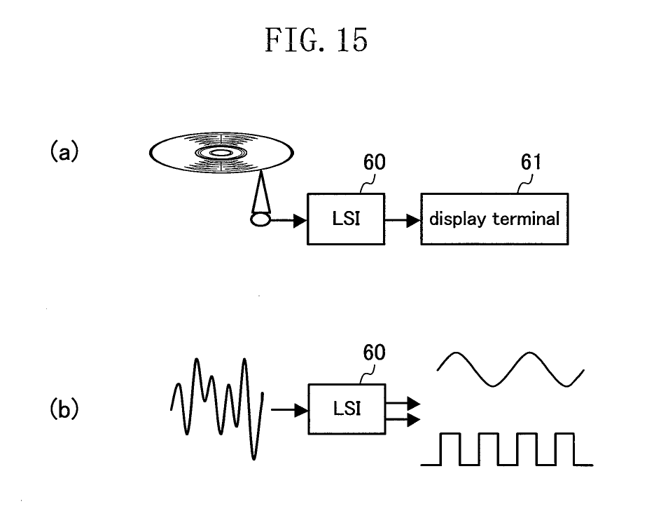

FIG. 15 shows a ninth embodiment of the present invention, and a video display apparatus including an LSI in which this information reproduction apparatus is incorporated.

The video display apparatus of FIG. 15 has an LSI 60 including a signal processing circuit (not shown) which receives a signal input by the aforementioned information reproduction apparatus (not shown in FIGS. 15(a) and 15(b)) via an optical disk shown in FIG. 15(a), radio communication shown in FIG. 15(b), or the like, and performs data extraction or the like with respect to a decoded signal from the information reproduction apparatus, thereby obtaining audio data or image data, and a display terminal 61 which emits audio data and also displays video data, the audio and video data having an analog or digital value and being output from the LSI 60.

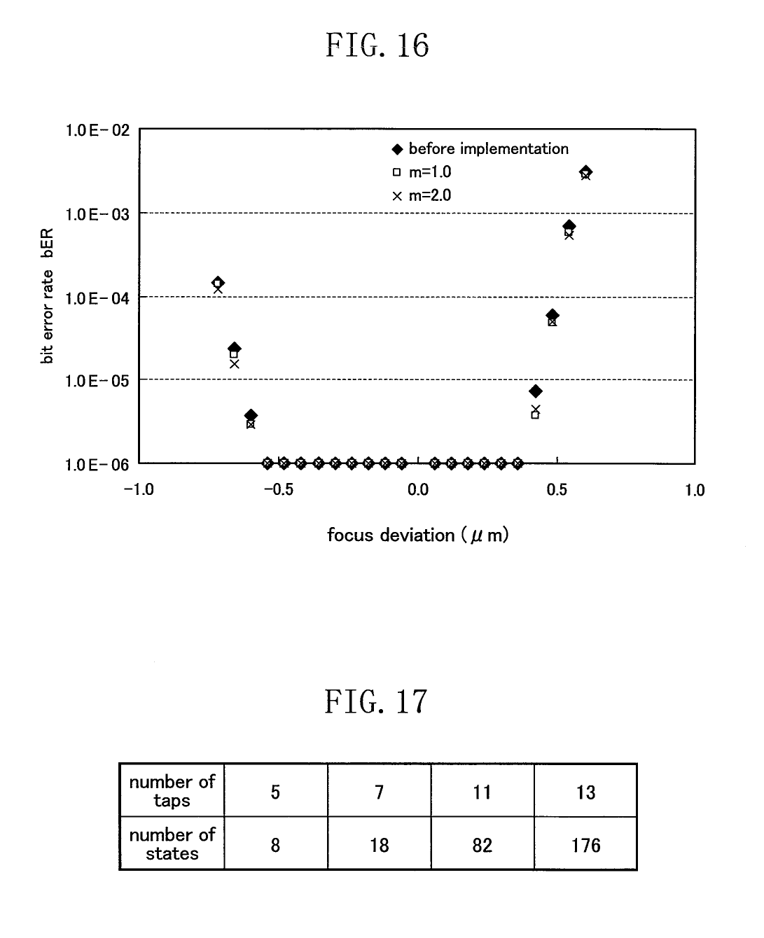

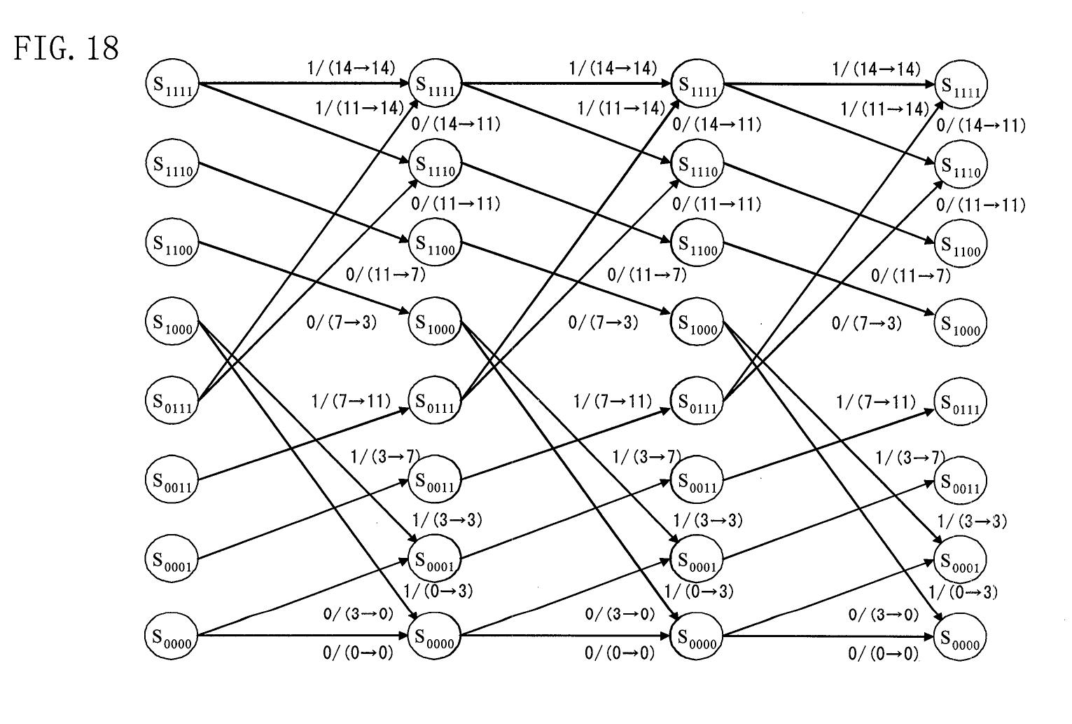

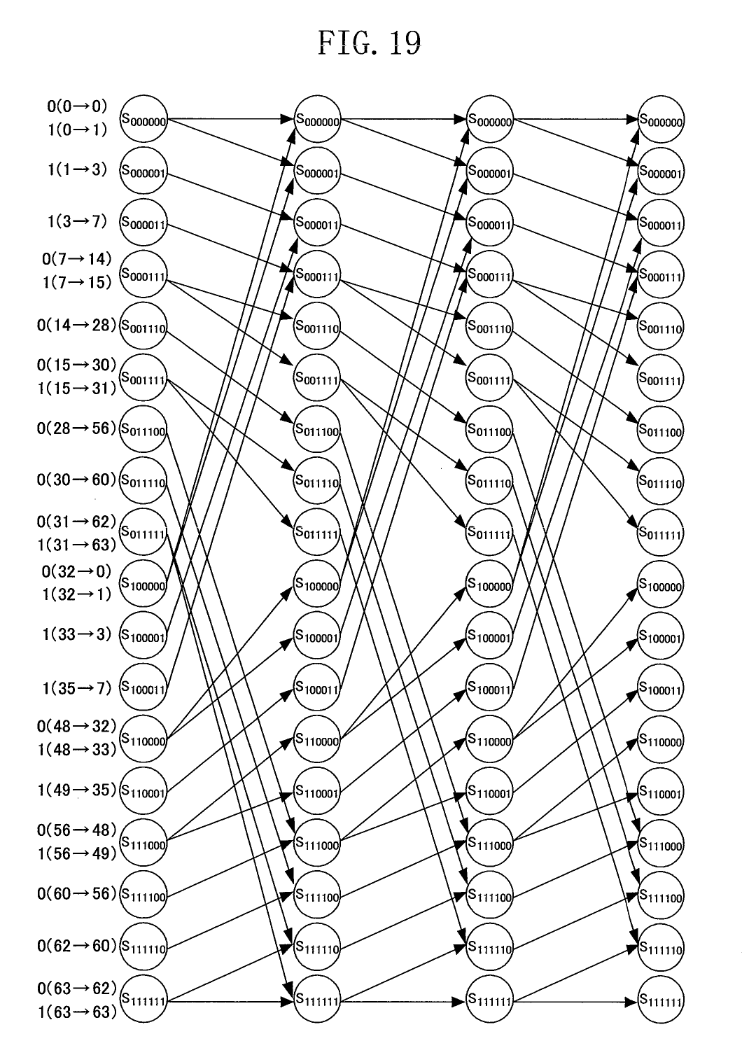

FIG. 16 shows a bit error rate bER when the FIR filter FIR2 having a four-tap configuration of FIG. 3 is used to perform a nonlinear waveform equalizing process before the reference value interpolation-type maximum likelihood decoder ASML. In FIG. 16, the horizontal axis represents deviations from a focus, and the vertical axis represents the bit error rates bER. FIG. 16 shows three cases, i.e., a case where a coefficient m is m=1.0, a case where m=2.0, and a case where the FIR filter FIR2 having the four-tap configuration is not provided (before implementation (conventional example)). As can be seen from FIG. 16, in the case of the present invention where m=1.0 and m=2.0, the number of errors is reduced and the bit error rate bER is improved as compared to the conventional example even if the focus deviation increases.

Although it has been assumed above that a signal from a recording medium, such as a DVD, a Blu-ray or the like, is an input signal, the present invention is also obviously applicable to a case where a signal which is supplied via a wireless communication path or a wired communication path, such as an optical fiber, a coaxial cable, a power line path or the like, is an input signal.

Also, the present invention may also obviously employ a configuration in which the output data of the A/D converter ADC of FIG. 1 or the like is stored in a memory, and a series of subsequent processes is performed with software.

### INDUSTRIAL APPLICABILITY

As described above, the present invention can provide maximum likelihood decoding which has a high level of error correction function while using a reference value interpolation-type maximum likelihood decoder having a relatively small number of taps, and therefore, is useful as an information reproduction apparatus employing the PRML read channel technique, and a storage apparatus, a communication apparatus or the like including the information reproduction apparatus.

1. An information reproduction apparatus for extracting data and recording timings of the data from a received signal, comprising:
an asynchronous clock generator configured to generate and output an asynchronous clock which is not necessarily synchronous with the data recording timings of the received signal, a frequency of the asynchronous clock being adjusted so that a rate of oversampling of the received signal with the asynchronous clock is synchronous with the recording timings of the received signal;
an A/D converter configured to convert the received signal from an analog signal to a digital signal at timings of the asynchronous clock of the asynchronous clock generator;
a nonlinear waveform equalizer having a run length determinator configured to receive digital data sampled by the A/D converter with the timings of the asynchronous clock and determine data having a specific run length contained in the digital data, and configured to perform a nonlinear waveform equalizing process with respect to the digital data from the A/D converter with the timings of the asynchronous clock so that only the data having the specific run length determined by the run length determinator, of the digital data from the A/D converter, is amplified;
a timing detector configured to generate a pseudo-synchronous clock based on the output signal of the A/D converter and the asynchronous clock generated by the asynchronous clock generator; and
a reference value interpolation-type maximum likelihood decoder configured to perform error correction with respect to an output signal of the nonlinear waveform equalizer at the timings of the asynchronous clock, and thereafter, generate decoded data at timings of the pseudo-synchronous clock of the timing detector.

2. The information reproduction apparatus of claim 1, wherein
the nonlinear waveform equalizer performs a nonlinear waveform equalizing process so that only data having a specific run length contained in the output signal of the A/D converter is amplified and data having the other run lengths is passed therethrough without amplification.

3. The information reproduction apparatus of claim 1, wherein
the nonlinear waveform equalizer performs a nonlinear waveform equalizing process so that a plurality of pieces of data having respective specific run lengths contained in the output signal of the A/D converter are amplified by different respective amplification factors.

4. (canceled)

5. The information reproduction apparatus of claim 1, wherein
the timing detector generates a frequency control signal which allows a rate of oversampling of the received signal with the asynchronous clock of the asynchronous clock generator to be synchronous with the recording timings of the received signal,
the asynchronous clock generator receives the frequency control signal of the timing detector and adjusts a frequency of the asynchronous clock to be generated, and
the nonlinear waveform equalizer performs a nonlinear waveform equalizing process using a pseudo-synchronous clock generated by the timing detector based on the adjusted asynchronous clock.

6. The information reproduction apparatus of claim 1 or 2, wherein
the nonlinear waveform equalizer performs a nonlinear waveform equalizing process by performing a pseudo-synchronization process of causing digital data input at the timings of the asynchronous clock to be pseudo-synchronous with data having the timings of the pseudo-synchronous clock of the timing detector, and thereafter, converts the data obtained by the pseudo-synchronization process into data having the asynchronous timings, and outputs the data having the asynchronous timings.

7. The information reproduction apparatus of claim 1 or 3, wherein
the nonlinear waveform equalizer performs the nonlinear waveform equalizing process at the timings of the pseudo-synchronous clock of the timing detector.

8. The information reproduction apparatus of claim 1, wherein
the nonlinear waveform equalizer performs a nonlinear waveform equalizing process using a transversal filter and an LMS (Least Mean Square) algorithm.

9. The information reproduction apparatus of claim 1, comprising:
a memory configured to previously hold a plurality of sets of coefficient values of the nonlinear waveform equalizer,
wherein a set of coefficient values corresponding to an output value of the reference value interpolation-type maximum likelihood decoder is supplied from the memory to the nonlinear waveform equalizer.

10. The information reproduction apparatus of claim 1 or 8, comprising:
a coefficient calculator configured to calculate an optimal coefficient value of the nonlinear waveform equalizer by learning.

11. The information reproduction apparatus of claim 1, wherein
a nonlinear waveform equalizing process is performed so that a plurality of pieces of data having respective specific run lengths contained in the output signal of the A/D converter are amplified by different respective amplification factors at the timings of the asynchronous clock of the asynchronous clock generator.

12. The information reproduction apparatus of claim 1, wherein
a nonlinear waveform equalizing process is performed so that a plurality of pieces of data having respective specific run lengths contained in the output signal of the A/D converter are amplified by different respective amplification factors at the timings of the pseudo-synchronous clock of the timing detector.

13. The information reproduction apparatus of claim 1, wherein
the timing detector generates a frequency control signal which allows a frequency which is an integral multiple of a specific frequency corresponding to an optical disk to be equal to a frequency of an asynchronous clock, based on TOC (Table of Contents) information read out from the optical disk, and
the asynchronous clock generator receives the frequency control signal of the timing detector, and adjusts a frequency of the asynchronous clock to be generated.

14. The information reproduction apparatus of claim 1, wherein
the timing detector generates a frequency control signal which allows a frequency which is an integral multiple of a specific frequency corresponding to an optical disk to be equal to a frequency of an asynchronous clock, based on laser reflectance information of the optical disk, and
the asynchronous clock generator receives the frequency control signal of the timing detector, and adjusts a frequency of the asynchronous clock to be generated.

15. A video display apparatus comprising:
an LSI having the information reproduction apparatus of any one of claims 1 to 14, and a signal processing circuit configured to obtain audio data and video data based on decoded data obtained by the information reproduction apparatus; and
a display terminal configured to receive the audio data and the video data from the LSI, and generate the audio data and display the video data.

16. The video display apparatus of claim 15, wherein
the information reproduction apparatus receives the received data from an optical disk including a DVD or a Blu-ray, a wireless communication path, or a wired communication path including an optical fiber, a coaxial cable or a power line path.
